(19) United States
(12) Patent Application Publication
(10) Pub. No.: US 2009/0041034 A1
(43) Pub. Date: Feb. 12, 2009

(54) Method and System for Characterizing Heterogeneous Communication Nodes

(75) Inventors: Mohamed Boucadair, Caen (FR); Yoann Noisette, May Sur Orne (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 12/224,571

(22) PCT Filed: Feb. 15, 2007
(86) PCT No.: PCT/FR2007/050808

§ 371 Date: Aug. 28, 2008

(30) Foreign Application Priority Data
Feb. 28, 2006 (FR) 0650681

(51) Int. Cl. H04L 12/56

(52) U.S. Cl. 370/400

(57) ABSTRACT

A method of sending data between heterogeneous nodes. The method includes a step of inserting a type indicator into a message (RE(1), I(1)) sent by a user agent in one of said nodes before setting up a communications session between said nodes, said type indicator representing the type of address associated with said user agent (A). The method quickly identifies risks of incompatibility between the types of two user agents (A, B) seeking to communicate with each other, with a view to resolving such incompatibilities if necessary. Application to intercommunication of IPv4, IPv6 or Dual Stack (DS) user agents in IP networks.

The field of the invention is that of telecommunications, more particularly that of IP telephony.

Internet Protocol (IP) networks are increasingly used as universal supports for a multitude of services and applications. The IP has had a federator role for many operators opting for this protocol to mutualize previously disparate service offers.

The IPv4 version of the Internet Protocol has been in use for some years.

To satisfy constraints imposed by such communications services and more particularly to accommodate increased requirements in terms of addresses, operators and network equipment manufacturers have united to specify a new generation communications protocol, known as IPv6, defined by specifications and analysis documents that are now at a sufficiently advanced stage of development for it to be possible to envisage operational deployment in the operators' networks.

Nevertheless, the introduction of this new generation protocol is causing significant problems linked to the need to guarantee interoperability and interworking between the IPv6 protocol and IPv4 protocol already deployed in IP networks. In the current state of the art solutions to those problems have been identified, but they have the disadvantage that they are operative not only at a “service” level (in particular in the application layer) but also at a “transport” level (in the IP layer). In the transport layer, mechanisms have been proposed and even standardized by the Internet Engineering Task Force (IETF), such as the NAT-PT technique and various tunneling techniques that encapsulate IPv6 data in IPv4 datagrams or vice-versa.

Furthermore, architectures and service platforms must be updated and adapted to enable interworking between clients situated in IP environments of different types (IPv4 and IPv6) as transparently as possible for the end user.

Among other multimedia activities, the IETF has standardized the Session Initiation Protocol (SIP), the main functions of which are initiating, modifying, and terminating multimedia sessions. The SIP is an interesting example for application of the present invention. It is based on the Service Description Protocol (SDP) for producing a description of parameters relating to the session concerned. Once negotiation between two parties to a call has succeeded, the parties can exchange media streams by activating a Real-time Transport Protocol (RTP). RTP session parameters are prenegotiated via SIP signaling messages, notably in the SDP part. They are mainly termination addresses and port numbers to be used at either end of a communications link to be set up.

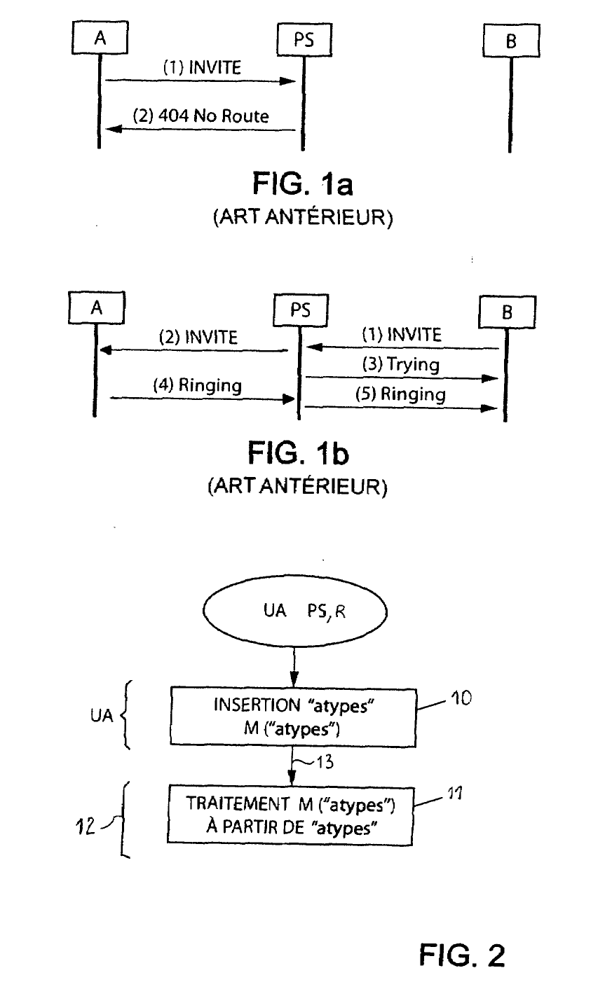

Since a first version of the SIP was described in Request For Comments (RFC) 2543 it has been compatible with IPv6. In theory, an implementation of the SIP easily decodes IPv4 and IPv6 addresses, which can be introduced into specific fields such as a “CONTACT” header or headers of the SDP part. However, the presence of such addresses can prevent SIP calls being set up if both terminals cannot be contacted in the same IP environment, i.e. if one has an IPv4 address and the other an IPv6 address. Thus when an IPv4 user agent initiates an SIP session with an IPv6 user agent A registered with an IPv4 location server (also known as a “Registrar” R), the resulting exchange of SIP messages is as shown in FIG. 1a, in which a first user agent A seeking to contact a second user agent B sends an “INVITE” message to a proxy server PS using an IPv4 address specific to it. Here the proxy server PS is attached to an IPv4-only environment. Once the message has been received by the proxy server PS, the proxy server submits a query to a location server, also known as a registration server, to recover the address of the second user agent B. Under the present assumption, that address is an IPv6 address and the proxy server PS does not know a route to that destination, given that the proxy server PS is of IPv4-only type. An error message is then sent to the user agent A indicating that it is impossible to set up an SIP session between the first and second user agents A and B. This error message is the “(2) 404 No Route” message shown in FIG. 1a.

If it is now assumed that the proxy server PS can nevertheless contact the location address of the first user agent A as well as that of the second user agent B, another exchange of SIP messages takes place, with the second user agent B attempting to call the first user agent A, as shown in FIG. 1b.

In this situation, the proxy server PS routes an “INVITE” message received from the second user agent B to the location address of the first user agent A. This “INVITE” message contains an SDP offer describing, in addition to the codecs (coders/decoders) offered by the first user agent B, an RTP port number and an address that the second user agent B can use to send and receive RTP streams. In FIG. 1b, that address is an IPv6 address. Thus when the user agent A receives this “INVITE” message, it can only refuse to open the session because it is an IPv4 client. Depending on how it is implemented, it can at best send back an error message indicating that it does not support network connections to the IP address of the user agent B. Thus SIP sessions cannot be set up in either of the above examples described with reference to FIGS. 1a and 1b.

Coexistence of IP addresses of different types can affect calls other than those graphically represented and described above. Thus calls to Dual Stack (DS) clients can also fail to terminate in the exchange of media streams, DS user agents being able to process both IPv4 and IPv6 address types. This is because the basic SIP provides for indicating only one IP address for sending or receiving media streams. To overcome this problem, RFC 4092 introduces new semantic features including an “sdp-anat” indicator to enable a user agent to announce and/or discover one or more address types. Thus DS user agents can indicate in their STP offer both their IPv4 address and their IPv6 address. By means of this technique, all calls from or to a DS user agent to or from single-version clients (i.e. clients compatible only with the IPv4 protocol or only with the IPv6 protocol) can terminate in successful SIP sessions.

In a situation where two nodes at the ends of a communications link intended to convey a given call are single-version nodes, the SIP telephone service operator concerned can use application level gateway (ALG) applications for modifying SDP offers to ensure consistency between the address type supported and the type contained in the received SIP messages. To this end SIP servers use information relating to the transport layer, and not specific to the SIP, to route calls or to decide to use ALG applications to change the content of the SDP offers. Such behavior of SIP servers is not covered by the standard.

Generally speaking, the problem linked to interconnecting two heterogeneous user agents (i.e. user agents of different IP types) has not been studied in detail by the telecommunications community. In particular, apart from an ANAT proposal described in RFC 4091 and RFC 4092, which solves part of the problem, there is no IETF document describing the behavior of SIP servers for routing calls connecting two user agents in two different IP environments.

Furthermore, the existing techniques have the following drawbacks:

using ALG applications and additional functions is not documented; the proxy server PS has no means specified by RFC 3261 to facilitate this task;

the proxy server PS must use information from the network layer (also referred to in the present document as the transport layer) to make decisions concerning the service layer; it must therefore take into account considerations other than the source address of the messages, the address used to contact the proxy server or to examine the SDP part; this risks degrading the performance of the proxy, which is configured a priori to process only service level information;

using these addresses is not optimized: one method of obtaining successful sessions would be to enable both user agents participating in a call to have addresses of two types so that the SDP negotiation always succeeds, but this would cause problems with optimizing use of the addressing space available to the operator (especially in IPv4);

the solution is not generic: the philosophy of call routing and intervention by the proxy server PS depends on the interconnection solution deployed at the transport level;

the proxy server PS has no means for determining if a user agent is of the IPv4, IPv6, or DS type.

The work of the inventors has lead them to conclude that, not withstanding a need that emerges from the above study, in the current state of the art there is no simple way to enable communication means in an IP communications network to identify the address type associated with a given user agent, which explains why most techniques for managing calls between heterogeneous nodes currently under study are insufficient and do not address service requirements enabling heterogeneous calls.

In proposing a transmission method enabling easy identification of the address type supported by a given user agent, the present invention offers a solution that does not have the above drawbacks.

A method of the invention for sending data between heterogeneous nodes is characterized in that it includes a step of inserting a type indicator into a message sent by a user agent in one of said nodes before setting up a communications session between said nodes, said type indicator representing the type of address associated with said user agent.

The invention provides a fast way to identify risks of incompatibility between the two types of user agent having to communicate with each other, with a view to overcoming this kind of incompatibility if necessary.

In particular, the invention enables a proxy server such as that referred to above to quickly identify the two types of user agent that have to communicate with each other to enable said server to identify and where appropriate deploy the resources necessary for effective setting up of a communications session between those agents, whether they are of the same type or not.

Here references to a user agent's “type” denote one or more versions of the Internet Protocol (for example IPv4, IPv6) that the user agent is able to employ via the network interface(s) of the SIP node that hosts it. Two nodes A and B are referred to as heterogeneous if the user agent type hosted by the node A is different from the user agent type hosted by the node B.

Thus a protocol of the invention can further include a step of classifying the user agent sending a type indicator according to three IP types: Pure IPv4, Pure IPv6 or Dual Stack.

In one particular embodiment of the invention, the insertion step is executed at the initiative of said user agent.

This enables the user agent to restrict calls that it sends or receives to the corresponding network interface and Internet Protocol type.

The type indicator can advantageously take the form of a coded numerical value representing an IPv4 protocol, an IPv6 protocol, or a Dual Stack (IPv4+IPv6) protocol.

Such numerical values can very easily be encoded on a few bits, and so implementing the invention does not cause any significant increase in the volume of messages exchanged for the purposes of a call.

In a first advantageous variant of the invention, a method as described above further includes a step of storing said type indicator with an identifier of the associated user agent.

Among other things, this storage step creates in a database and keeps up to date a reference table for easily and directly identifying an IP address type associated with each user agent for which the type indicator has been stored. This database can be fed spontaneously by each user agent on initializing a connection or by regular updating and managed by a location server, with which user agents register on initializing a communications session or at the expiry of the registration period.

In a second advantageous variant of the invention, which can be used instead of or in conjunction with the first variant, a method as described above can further include, in the event of incompatibility between a type indicator associated with a user agent that sent said invitation message and a type indicator associated with a destination user agent of said invitation message, a step of transforming an address included in a message of invitation to enter into communication with a user agent.

According to this variant of the invention, simply comparing the type indicators associated with the calling and called user agents enables any incompatibility between them to be remedied even before any attempt is made to set up a connection between the calling and called parties.

For example, the invention is used with advantage in an IP telephone application known as VoIP (Voice over IP) or generally grouped under the heading conversational services.

The invention then addresses the general problem of SIP-based signaling services defined by RFC 3162 and deployed both for IPv4 clients and for IPv6 clients. Those services can be voice, video, presence, etc. services.

As explained above, the invention proposes a simple mechanism for facilitating setting up SIP sessions between two heterogeneous clients, one attached to an IPv4 domain and the other to an IPv6 domain.

By using the invention, a SIP proxy server is able to route SIP calls and to intervene to modify (or to cause to be modified) the content of SDP offers defined by RFC 2327 conveyed in SIP messages, to enable sessions to be set up between heterogeneous nodes. In contrast, if the present invention is not implemented, the SIP proxy server must have access to information other than that of the application layer, in particular information relating to the network layer, to orient its choice of call routing and to optimize use of ALG applications, which are responsible for modifying the SIP messages to achieve successful SIP sessions. Failing the use of homogeneous protocol stacks, some SIP sessions cannot take place without such intervention by the SIP server and ALG applications.

The invention allows interworking of heterogeneous SIP nodes and simplifies and therefore facilitates call routing in SIP telecommunications systems.

In particular, the invention optimizes the use of IP addresses and does not require the processing of SIP messages by a SIP proxy server to rely on information from the transport layer in order to decide on the processing required by SIP messages received by the server.

In one embodiment specific to the application example referred to here, the type indicator can be inserted into a “CONTACT” field included in SIP query messages.

Introducing the type indicator into the query message informs the location server and the proxy server of the kinds of IP addresses supported by the network interfaces available in a user agent. Moreover, the proxy server can then use that type indicator to process a query message to route it to its destination, without having to access information in the network layer.

Transposing application of the first variant of the invention described above to the present example could see the user agent inserting its type indicator into a “REGISTER” message.

Thus, on reception of a “REGISTER” message, the location server proceeds to store the registration address, the registration expiry time, and the type indicator. It can also store other data.

Transposing application of the second variant of the invention described above to the present example could see the proxy server transforming an address included in an “INVITE” message in the event of incompatibility between a type indicator associated with the user agent that sent said “INVITE” message and a type indicator associated with the destination user agent of said “INVITE” message.

Such incompatibilities arise in particular if the user agents sending and receiving the “INVITE” message are of different types.

In such applications of the invention, a proxy server that has to perform call routing processing using a gateway at the application level for modifying call messages between two user agents of different types executes such processing:

either on the basis of a classification stored in a registration database updated by the location server and containing the nature of the calling and called user agent types;

or on the basis of a classification stored in the registration database containing the nature of the called user agent type and the type indicator contained in the “INVITE” message transmitted by the calling user agent.

As is clear from the above description, the invention also relates, by way of product obtained directly by its implementation in the application described above, to any signal carrying a query message including a type indicator representing the nature of an IP address associated with a user agent sending the message, which message can be a “REGISTER”, “INVITE” or “200 OK” message, for example. The type indicator can in particular be inserted into a “CONTACT” field.

A hardware aspect of the invention relates to a system for sending data between heterogeneous nodes, characterized in that it includes means for inserting a type indicator into a message sent by a user agent in one of said nodes before setting up a communications session between said nodes, said type indicator representing the type of address associated with that user agent.

A variant of this hardware aspect of the invention relates to a transmission system as described above further including means for sorting and classifying user agents sending query messages on the basis of the type indicators of said agents and a database adapted to store said classification.

Another variant of this hardware aspect of the invention relates to a transmission system as described above further including means for comparing type indicators specific to a calling user agent and a called user agent.

Another hardware aspect of the invention, constituting means useful for implementing it, relates to computer programs including a series of program code instructions for executing certain steps of a method as described above when said program is executed in a computer.

The invention can be better understood in the light of the following description, given by way of non-limiting example and with reference to the appended drawings, in which, in addition to FIGS. 1a and 1b relating to the prior art:

FIG. 2 represents, by way of illustration, a flowchart of the essential steps of the method of the invention;

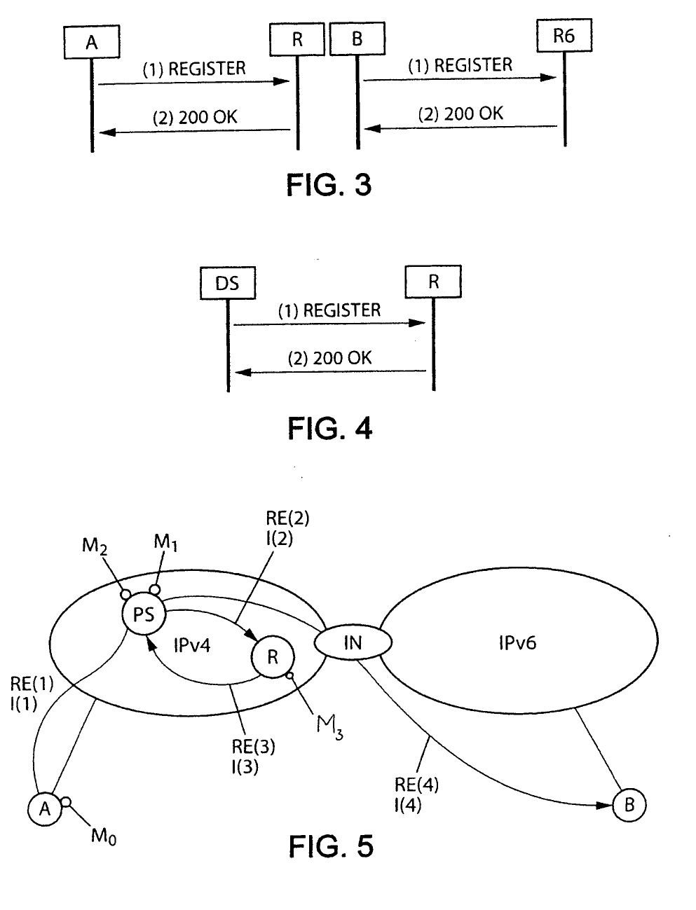

FIG. 3 represents, by way of illustration, a first example of registration of IPv4 and IPv6 user agents;

FIG. 4 represents, by way of illustration, a second example of registration of a Dual Stack user agent; and

FIG. 5 represents a system of the invention for interworking of heterogeneous SIP nodes, operative in the situation of a user agent sending a “REGISTER” message to a location server and of an “INVITE” message passing in transit through a proxy server.

A more detailed description of the method of the present invention is given below with reference to FIG. 2 and the subsequent figures.

Generally speaking, each heterogeneous node formed, for example, by an IPv4, IPv6 or Dual Stack (DS) hybrid IP terminal includes a user agent UA of particular type, that type corresponding to the version of the IP that the user agent is able to use via the network interface(s) available to the terminal concerned.

As shown in FIG. 2, the method of the invention, in a step 10, inserts into a query message M sent by the user agent UA a type indicator “atypes”. After this insertion, the query message is denoted M(“atypes”). Such query messages include registration messages to a location server (also known as a “Registrar”) R, for example. There can also be messages sent to a proxy server PS, for example a message prompting entry into communication with another user agent.

After transmission (13) of the message into which the type indicator has been inserted, the method of the invention processes (11) the query message M(“atypes”) on the basis of the time indicator “atypes” that it contains. This processing is effected in a unit 12 that can be the location server for a registration message or the proxy server for a message prompting entry into communication with another agent.

The processing 11 carried out in the proxy server 12 routes the message without it being necessary for the proxy server 12 to access information in the transport layer.

It is clear in particular that the type indicator “atypes” contains coded numerical data representing the nature of the network interfaces and the Internet Protocol available to the user agent sending the message in order to provide this information to the location server and the proxy server 12:

to enable the location server to proceed to registration 11 of the type indicator associated with an identifier of the user agent, so as to maintain a database providing information on the types of the various user agents liable to attempt to communicate;

to enable the proxy server 12 to effect the routing 11 in the absence of access to any information in the transport layer used to transmit the M(“atypes”) message.

An example of the implementation of the step 10 of the method of the invention represented in FIG. 2 is described below with reference to FIGS. 3 and 4.

In one particular type of embodiment, the type indicator “atypes” is inserted into the “CONTACT” field of SIP queries, in particular “REGISTER” and “INVITE” queries. To illustrate the definition of this indicator, the description ABNF of the “CONTACT” field, as defined by RFC 3162, is indicated below.

In the following description ABNF, elements known in the art and described in RFC 3162 are in ordinary type and additional descriptive elements are in bold type.

The whole of the new description ABNF is set out in table T1 below:

TABLE T1

| | |
|---|---|
| Contact = | ( [symbol] Contact [symbol] / “m”) HCOLON |
| | (STAR / (contact-param *(COMMA contact-param))) |
| | COMMA atypes |
| contact-param = | (name-addr / addr-spec) *(SEMI contact-params) |
| name-addr = | [display-name] LAQUOT addr-spec RAQUOT |
| addr-spec = | SIP-URI / SIPS-URI / absoluteURI |
| display-name = | *(token LWS)/ quoted-string |
| contact-params = | c-p-q / c-p-expires / contact-extension |
| c-p-q = | [symbol] q [symbol] EQUAL qvalue |
| c-p-expires = | [symbol] expires [symbol] EQUAL delta-seconds |
| contact- = | generic-param |
| extension | |
| delta-seconds = | 1*DIGIT |
| atypes = | [symbol] atypes [symbol] EQUAL 4/6/0 |

A user agent may seek to restrict incoming or outgoing calls:

at its IPv4 interface;

at its IPv6 interface;

or at both types of interface, if it is equipped with a Dual Stack (DS) interface (i.e. one compatible with both protocol versions IPv4 and IPv6).

This operation is notified by means of the type indicator “atypes”.

A user agent can be configured so as not to announce an effective availability by setting the type indicator “atypes” to the appropriate value. Note that the IPv6 interface is deemed available only if one of the addresses configured is of global scope (the IPv6 protocol distinguishes between “link local” and “global” type addresses. Addresses of local scope cannot be routed beyond the local network, unlike addresses of global scope, which can be so routed (i.e. connected beyond the local network). During registration, the SIP user agent sends a “REGISTER” message with an extended “CONTACT” field as set out in Table T1 containing the additional heading “atypes”, which can take the following values:

4 if the user agent supports only IPv4;

6 if the user agent supports only IPv6;

0 if the user agent is Dual Stack capable.

A user agent can indicate to the proxy server PS that it supports only the IPv4 protocol by setting the “atypes” type indicator to 4 (even though the user agent is of the Dual Stack (DS) type, for example) or only the IPv6 protocol by setting the type indicator “atypes” to 6 or that it supports a Dual Stack protocol DS by setting the type indicator “atypes” to 0 in the “REGISTER” message that it sends to the registration server R.

In FIG. 3, R and R6 indicate location servers associated with the user agents A and B, respectively.

### Example of IPv4 User Agent:

It is assumed that user agent A is an IPv4 user agent with the address 192.165.25.2. As represented in FIG. 3, the user agent A sends the location server R the “(1) REGISTER” message set out in table T2:

TABLE T2

| | |
|---|---|
| REGISTER | sip:r.test.evi SIP/2.0 |
| Via: | SIP/2.0/UDP 192.165.25.2:5062;branch= |
| | z9hG4bK00e31d6ed |
| Max-Forwards: | 70 |
| Content-Length: | 0 |
| To: | A <sip:A@test.evi> |
| From: | A <sip: A@test.evi >;tag=ed3833bd7363e68 |
| Call-ID: | a8a83b610ae5d242289dfc1c78b7f1d8@test.evi |
| CSeq: | 1830746364 REGISTER |
| Contact: | A <sip:A@192.165.25.2:5062>;expires=900, atypes=4 |

The registration server R responds to the user agent A with the “(2) 200 OK” message set out in Table T3:

TABLE T3
SIP/2.0 200 OK

| | |
|---|---|
| Call-ID: | a8a83b610ae5d242289dfc1c78b7f1d8@evi.biz |
| CSeq: | 1830746365 REGISTER |
| From: | A <sip:A@test.evi>;tag=ed3833bd7363e68 |
| To: | A <sip:A@test.evi>;tag=3ab7fe89d998709 |
| Via: | SIP/2.0/UDP 192.165.25.2:5062;branch= |
| | z9hG4bK00e31d6ed |
| Content-Length: | 0 |
| Contact: | A <sip:A@192.165.25.2:5062>;expires=900, atypes=4 |

### Example of IPv6 User Agent:

It is assumed that user agent B is an IPv6 user agent with the address 2001:688:1ffb:ff80::2. As shown in FIG. 3, the user agent B sends the location server R6 the “(1) REGISTER” message set out in Table T4:

TABLE T4

| | |
|---|---|
| REGISTER | sip:r6.test.evi SIP/2.0 |
| Via: | SIP/2.0/UDP |
| | [2001:688:1ffb:ff80::2]:5062;branch= |
| | z9hG4bK00e31d6ed |
| Max-Forwards: | 70 |
| Content-Length: | 0 |
| To: | B <sip:B@test.evi> |
| From: | B <sip:B@test.evi >;tag=ed3833bd7363e68 |
| Call-ID: | a8a83b610ae5d242289dfc1c78b7f1d8@test.evi |
| CSeq: | 1830746364 REGISTER |
| Contact: | B <sip:B@[2001:688:1ffb:ff80::2]:5062>;expires=900, |
| | atypes=6 |

The registration server R6 responds to confirm registration with the “(2) 200 OK” message set out in Table T5:

TABLE T5
SIP/2.0 200 OK

| | |
|---|---|
| Call-ID: | a8a83b610ae5d242289dfc1c78b7f1d8@evi.biz |
| CSeq: | 1830746365 REGISTER |
| From: | B <sip:B@test.evi >;tag=ed3833bd7363e68 |
| To: | B <sip:B@test.evi >;tag=3ab7fe89d998709 |
| Via: | SIP/2.0/UDP[2001:688:1ffb:ff80::2]:5062;branch= |
| | z9hG4bK00e31d6ed |
| Content- | 0 |
| Length: | |
| Contact: | B <sip:B@[2001:688:1ffb:ff80::2]:5062>;expires=900, |
| | atypes=6 |

The IP address in the “CONTACT” field can be a unique address of a type other than that indicated in the type indicator field “atypes”. A user agent setting the type indicator “atypes” to 6 can use an IPv4 address in the “CONTACT” field or a user agent setting the type indicator “atypes” to 0 can declare only one address, and not two, as described below. The address contained in the “CONTACT” field is used by the SIP proxy server to route signaling messages. Media messages are transmitted to the user agent via the IPv6 interface, because the user agent has been declared to its proxy server PS as an IPv6 user agent (on the basis of the type indicator inserted into messages that it sends to the proxy server or on the basis of the type indicator stored for this user agent by the location server).

Example of DS User Agent with Only One Address in the “CONTACT” Field:

Referring to FIG. 4, it is assumed that the user agent is a Dual Stack (DS) user agent with the address 2001:688:1ffb:ff80::2/192.168.25.5. As represented in FIG. 4:

The DS user agent, during a registration phase, sends its location server R the “(1) REGISTER” message set out in table T6:

TABLE T6

| | |
|---|---|
| REGISTER | sip:r.test.evi SIP/2.0 |
| Via: | SIP/2.0/UDP 192.168.25.5:5062;branch= |
| | z9hG4bK00e31d6ed |
| Max-Forwards: | 70 |
| Content-Length: | 0 |
| To: | DS <sip:DS@test.evi> |
| From: | DS <sip:DS@test.evi >;tag=ed3833bd7363e68 |
| Call-ID: | a8a83b610ae5d242289dfc1c78b7f1d8@test.evi |
| CSeq: | 1830746364 REGISTER |
| Contact: | DS <sip:DS@192.168.25.5:5062>;expires=900, |
| | atypes=0 |

The location server R6 responds to confirm registration with a “(2) 200 OK” message set out in table T7:

TABLE T7
SIP/2.0 200 OK

| | |
|---|---|
| Call-ID: | a8a83b610ae5d242289dfc1c78b7f1d8@evi.biz |
| CSeq: | 1830746365 REGISTER |
| From: | DS <sip:DS@test.evi >;tag=ed3833bd7363e68 |
| To: | DS <sip:DS@test.evi >;tag=3ab7fe89d998709 |
| Via: | SIP/2.0/UDP 192.168.25.5:5062;branch= |
| | z9hG4bK00e31d6ed |
| Content-Length: | 0 |
| Contact: | DS <sip:DS@192.168.25.5:5062>;expires=900, |
| | atypes=0 |

Processing of the Indicator “atypes”:

On reception of the “REGISTER” message, the location server R also stores the address of record (AOR), the registration expiry time, and the type indicator “atypes”. This data (and possibly other data) is stored in a registration database managed by the location server. It can be updated by other “REGISTER” messages coming from the same user agent. This processing replaces that initially specified in RFC 3261.

Using information from the type indicator “atypes”, the location server classifies its user agents in three categories:

Pure IPv4;

Pure IPv6;

Dual Stack (DS).

This classification is accessible to the proxy server simply by consulting the registration database managed by the location server. It can also be effected directly by the proxy server simply reading the type indicator inserted by a user agent into a message intended for the proxy server, as described below.

User agents can also set the type indicator “atypes” when they send an “INVITE” message.

The proxy server PS has to send SIP messages without modifying their content in the following situations (CASE-1):

IPv4 to IPv4;

IPv6 to IPv6;

IPv4 to DS and DS to IPv4;

IPv6 to DS and DS to IPv6;

DS to DS.

In the aforementioned CASE-1 situation, the user agents are referred to as compatible because they are of the same type (or, more generally with DS user agents, because they have at least one type in common) and can therefore dialogue using the same IP version.

SIP messages making available IP addresses of the called and calling user agents of the same type after modification are modified only in the following situations (CASE-2):

IPv6 to IPv4;

IPv4 to IPv6.

In the aforementioned CASE-2 situation, the user agents are referred to as incompatible because they are not of the same type and therefore cannot communicate.

For call routing and the decision to use an ALG application or to modify the SIP messages to obtain successful sessions between two user agents of different types, the proxy server (PS) can:

Either examine the registration database maintained by the location server:

In this situation, the proxy server PS interrogates the location server R for the calling and called user agent types. The proxy server PS can then decide to modify the SDP content of the SIP message to harmonize it with the address type supported by the called party, in a scenario that is part of the CASE-2 situation. The example represented in FIG. 5 illustrates this mode of operation via a call between an IPv4 user agent A and an IPv6 user agent B. The functions interconnecting the IPv4 and IPv6 networks are represented by the node IN, which serves as a relay station and in particular executes protocol translation between IPv4 datagrams and IPv6 datagrams.

It is assumed that the user agent B is an IPv6 user agent. On initialization of the service, the user agent B was registered with the location server R by setting the type indicator “atypes” to 6 and the user agent A was registered with the location server R by setting the type indicator “atypes” to 4. For simplicity, this preliminary registration phase is not represented in FIG. 5.

The user agent B is known in the IPv6 environment by an IPv6 address that is translated into an IPv4 address by IPv6-IPv4 interconnection mechanisms such as the NAT-PT mechanism. The user agent B is then identified as an IPv6 user agent and the user A as an IPv4 user agent. If the user agent A is seeking to set up a session with the user agent B, the following SIP messages are exchanged:

RE (1) the user agent A sends an “INVITE” message to the proxy server PS;

RE (2) the proxy server PS interrogates the location server R for the location address of the user agent B and the type indicators “atypes” of the user agents A and B as indicated during registration;

RE (3) the location server R sends back the address of the user agent B, the type indicator “atypes” of the user agent B, and the type indicator “atypes” of the user agent A;

RE (4) the proxy server PS compares the two type indicators “atypes” of the user agents A and B. On the basis of the classification of types available on the location server R, the proxy server PS verifies that A is an IPv4 user agent and B is an IPv6 user agent. The proxy server PS then invokes the adaptation mechanisms to modify the initial SDP offer of the user agent A so that it contains an IPv6 address. The proxy server PS then sends the modified “INVITE” message to the address of the user agent B as indicated by the location server R.

Without this procedure, the proxy server PS would have no means of routing the call to the user agent B and for invoking the adaptation functions necessary for correct routing of the message to the user agent B. The proxy server PS would send the query back to the user agent B without modifying it, and in this situation the SIP session between the user agents A and B could not take place (see FIG. 1b).

Or examine the registration database, and the type indicator “atypes” conveyed in the “INVITE” message:

In this situation, the proxy server PS interrogates the location server R for the type of the called user agent B. The type of the calling user agent A is deduced from the “INVITE” message it sent. The proxy server PS can then decide to modify the content of the SIP message to harmonize it with the address type supported by the called user agent B; this scenario is part of the CASE-2 situation. For this option, a user agent can restrict the type of address to be used for each session. The example described with reference to FIG. 5 illustrates this other mode of operation via a call between the IPv4 user agent of and an IPv6 user agent.

It is assumed that user agent B is an IPv6 user agent. On starting up the service, the user agent B was registered with the location server R by setting the type indicator “atypes” to 6 and the user agent A was registered with the location server R by setting the type indicator “atypes” to 4. Here the user agent B is as an IPv6 user agent and the user agent A is identified as an IPv4 user agent. If the user agent A is seeking to set up a session with the user agent B, the following SIP messages are exchanged:

I (1) the user agent A sends an “INVITE” message to the proxy server PS;

I (2) the proxy server PS interrogates the location server R for the location address of the user agent B and the type indicator “atypes” of the user agent B as indicated during registration;

I (3) the location server R sends back the address and the type indicator “atypes” of the user agent B;

I (4) the proxy server PS extracts the type indicator “atypes” of the user agent A from the “I(1) INVITE” query and compares it to that of the user agent B. On the basis of the classification of types available from the location server R, the proxy server PS verifies that user agent A is an IPv4 user agent and user agent B is an IPv6 user agent. The proxy server PS then invokes the adaptation mechanisms to modify the initial SDP offer of the user agent A so that it contains a IPv6 address. The proxy server PS then sends the modified “INVITE” message to the address of the user agent B as indicated by the location server R.

To use the protocol shown in FIG. 5, the proxy server PS advantageously includes a module M₁ for comparing type indicators associated with a calling user agent and a called user agent. If the module M₁ determines that the calling and called user agents are of different types, the proxy server activates a module M₂ to call a resource for modifying the IP address of the calling user agent. The modification resource, which is external to the proxy server PS, is not shown in FIG. 5. The modules M₁ and M₂ can be implemented in the form of computer programs. For simplicity they are designated by the same alphanumeric reference in FIG. 5.

The invention further covers a computer program M₀ for execution by a computer or a dedicated device such as a IPv4, IPv6 or Dual Stack user agent of an IP terminal. When the computer program M₀ is executed, its code instructions insert into a query message sent by the user agent UA a type indicator “atypes” representing the type of one or more IP addresses supported by the network interfaces available in that user agent UA, as described above and as represented in FIGS. 2, 3 and 4.

As indicated above, the invention further covers a computer program M₁, M₂ including a series of instructions for execution by a computer or a dedicated device such as a proxy server PS. When the program M₁, M₂ is executed, those instructions process a query message transmitted by a user agent to the proxy server and containing a type indicator “atypes” representing the type of one or more IP addresses supported by the network interfaces available in that user agent. This kind of processing routes the query message to its destination in the absence of access to information contained in the transport layer, as described above and shown in FIGS. 2 to 5.

The invention also covers a computer program M₃ comprising code instructions for execution by a computer or a dedicated device such as a location server R. When the program M₃ is executed, the instructions extract a type indicator from a registration message sent by a user agent and store that type indicator in relation to an identifier of the user agent concerned in a registration database. They also classify the user agent concerned into one of the three IP categories (IPv4, IPv6, Dual Stack), as described above and shown in FIGS. 2 to 5.

1. A method of sending data between heterogeneous nodes, comprising at least one step of inserting a type indicator into at least one message sent by a user agent in one of said nodes before setting up a communications session between said nodes, said type indicator representing the type of at least one address associated with said user agent.

2. The method according to claim 1, wherein said type indicator is inserted into a “CONTACT” field included in an SIP query message.

3. The method according to claim 1, wherein the insertion step is executed at the initiative of said user agent.

4. The method according to claim 1, wherein said type indicator is a coded numerical value representing the IPv4 protocol, the IPv6 protocol or the Dual Stack protocol comprising the IPv4 and IPv6 protocols.

5. The method according to claim 1, further comprising a step of storing said type indicator with reference to an identifier of the associated user agent.

6. The method according to claim 4, further comprising a step of classifying a user agent sending a type indicator in one of three IP type categories: Pure IPv4, Pure IPv6 or Dual Stack.

7. The method according to claim 1, further comprising a step of transforming at least one address included in a message of invitation to enter into communication with a user agent, said step being performed in the event of incompatibility between a type indicator associated with a user agent that sent said information message and a type indicator associated with a destination user agent of said invitation message.

8. A signal conveying a query message including a type indicator representing at least one type of IP address assigned to a user agent sending the message.

9. A system for sending data between heterogeneous nodes, characterized in that it includes means for inserting a type indicator into at least one message sent by a user agent in one of said nodes before setting up a communications session between said nodes, said type indicator representing the type of at least one address associated with said user agent.

10. The system according to claim 9, further comprising means for sorting and classifying user agents sending query messages on the basis of the type indicators of said agents and a database adapted to store said classification.

11. The system according to claim 10, further comprising means for comparing type indicators specific to at least one calling user agent and at least one called user agent.

12. A computer program including a series of program code instructions for executing the steps of a method according to claim 1 when said program is executed in a computer.

13. A computer program including a series of program code instructions for executing the steps of a method according to claim 5 when said program is executed in a computer.

14. A computer program including a series of program code instructions for executing the steps of a method according to claim 6 when said program is executed in a computer.
